(19) United States
(12) Patent Application Publication
(10) Pub. No.: US 2016/0312953 A1
(43) Pub. Date: Oct. 27, 2016

(54) DUAL PARALLEL OUTLET CHECK VALVE

(71) Applicant: Graco Minnesota Inc., Minneapolis, MN (US)

(72) Inventors: John C. Holman, Ham Lake, MN (US); Ryan David Kennedy, Little Canada, MN (US); Suresha Saragur Nijaguna, Plymouth, MN (US)

(21) Appl. No.: 15/136,297

(22) Filed: Apr. 22, 2016

Related U.S. Application Data
(60) Provisional application No. 62/151,587, filed on Apr. 23, 2015.

(51) Int. Cl. F16N 23/00; F16N 13/02; F16K 15/04

(52) U.S. Cl. CPC F16N 23/00; F16K 15/044; F16N 13/02

(57) ABSTRACT

A dual parallel outlet check valve includes a first one-way valve and a second one-way valve. The first one-way valve and the second one-way valve are normally closed valves. Both the first one-way valve and the second one-way valve are disposed in a valve housing, and the first one-way valve is disposed adjacent to and runs parallel with the second one-way valve. The first one-way valve allows lubricant to flow downstream from a fluid chamber to build a downstream pressure, thereby causing lubricant applicators to dispense lubricant. The second one-way valve allows lubricant to flow upstream back into the fluid chamber, thereby allowing the downstream pressure to drop and the lubricant applicators to reset.

### CROSS-REFERENCE TO RELATED APPLICATION

This application claims priority to U.S. Provisional Application No. 62/151,587 filed on Apr. 23, 2015, and entitled “DUAL PARALLEL OUTLET CHECK,” the disclosure of which is incorporated by reference in its entirety.

### BACKGROUND

Machinery often requires lubrication to function. Seals, pistons, bearings, and other parts require lubrication with small, measured amounts of grease or oil over short, frequent time intervals to prevent wear, corrosion, over-lubrication, or under-lubrication. Lubricant fluid is injected at specific locations that require lubrication by lubricant injectors. Lubricant fluid is drawn from a lubricant reservoir and pumped to the lubricant injectors via a lubrication line. The lubricant injectors are configured to dispense a set, small amount of lubricant fluid to the specific location within the machinery once the pressure within the lubrication line reaches a predetermined level. After the lubricant injectors have dispensed the lubricant, the pressure within the lubrication line is relieved, thereby resetting the lubricant system for another lubrication cycle.

### SUMMARY

In one embodiment, an outlet valve includes a valve body having a fluid chamber port and a system port and a two-way valve disposed within the valve body between the fluid chamber port and the system port. The two-way valve includes a first flow path having a first inlet adjacent the fluid chamber port and a first outlet adjacent the system port, a first one-way valve disposed within the first flow path, wherein the first one-way valve is configured to allow flow from the first inlet to the first outlet, a second flow path extending parallel to the first flow path, the second flow path having a second inlet adjacent the system port and a second outlet adjacent the fluid chamber port, and a second one-way valve disposed within the second flow path, wherein the second one-way valve is configured to allow flow from the second inlet to the second outlet.

In another embodiment, a lubricant pump includes a pump base defining a fluid chamber, and having a throat, a fill port, and an outlet port, a working fluid cylinder attached to the pump base, a lubricant reservoir attached to the pump base, and configured to provide lubricant to the fluid chamber through the fill port, a piston disposed within the working fluid cylinder, a piston rod extending from the piston and into the fluid chamber through the throat, and an outlet valve attached to the outlet port. The outlet valve includes a valve body having a fluid chamber port and a system port, with the fluid chamber port disposed within the outlet port, and a two-way valve disposed within the valve body between the fluid chamber port and the system port. The two-way valve includes a first flow path having first inlet adjacent the fluid chamber port and a first outlet adjacent the system port, a first one-way valve disposed within the first flow path, a second flow path extending parallel to the first flow path, the second flow path having a second inlet adjacent the system port and a second outlet adjacent the fluid chamber port, a second one-way valve disposed within the second flow path. The first one-way valve is configured to allow lubricant to flow downstream from the fluid chamber. The second one-way valve is configured to allow lubricant to flow upstream to the fluid chamber.

In yet another embodiment, a lubrication system includes a pump, a lubricant supply line configured to provide lubricant downstream to lubricant applicators, and a working fluid supply connected to the pump through a first working fluid supply line and a second working fluid supply line. The pump includes a pump base defining a fluid chamber, and having a throat, a fill port, and an outlet port, a working fluid cylinder attached to the pump base, a lubricant reservoir attached to the pump base, and configured to provide lubricant to the fluid chamber through the fill port, a piston disposed within the working fluid cylinder, a piston rod extending from the piston and into the fluid chamber through the throat, and an outlet valve attached to the outlet port. The outlet valve includes a valve body having a fluid chamber port and a system port, with the fluid chamber port disposed within the outlet port, and a two-way valve disposed within the valve body between the fluid chamber port and the system port. The two-way valve includes a first flow path having first inlet adjacent the fluid chamber port and a first outlet adjacent the system port, a first one-way valve disposed within the first flow path, a second flow path extending parallel to the first flow path, the second flow path having a second inlet adjacent the system port and a second outlet adjacent the fluid chamber port, a second one-way valve disposed within the second flow path. The first one-way valve is configured to allow lubricant to flow downstream from the fluid chamber. The second one-way valve is configured to allow lubricant to flow upstream to the fluid chamber. The first working fluid supply line provides working fluid to the working fluid cylinder to drive the piston in a forward stroke. The second working fluid supply line provides working fluid to the working fluid cylinder to drive the piston in a reverse stroke.

### BRIEF DESCRIPTION OF THE DRAWINGS

FIG. 1 is a schematic diagram of a lubrication system.

FIG. 2A is a cross-sectional view of a lubricant pump in a first operating state of a forward stroke.

FIG. 2B is a cross-sectional view of a lubricant pump in a second operating state of a forward stroke.

FIG. 2C is a cross-sectional view of a lubricant pump in a third operating state of a forward stroke.

FIG. 3A is a cross-sectional view of a lubricant pump in a first operating state of a return stroke.

FIG. 3B is a cross-sectional view of a lubricant pump in a second operating state of a return stroke.

FIG. 3C is a cross-sectional view of a lubricant pump in a third operating state of a return stroke.

FIG. 4 is cross-sectional view of an outlet valve.

### DETAILED DESCRIPTION

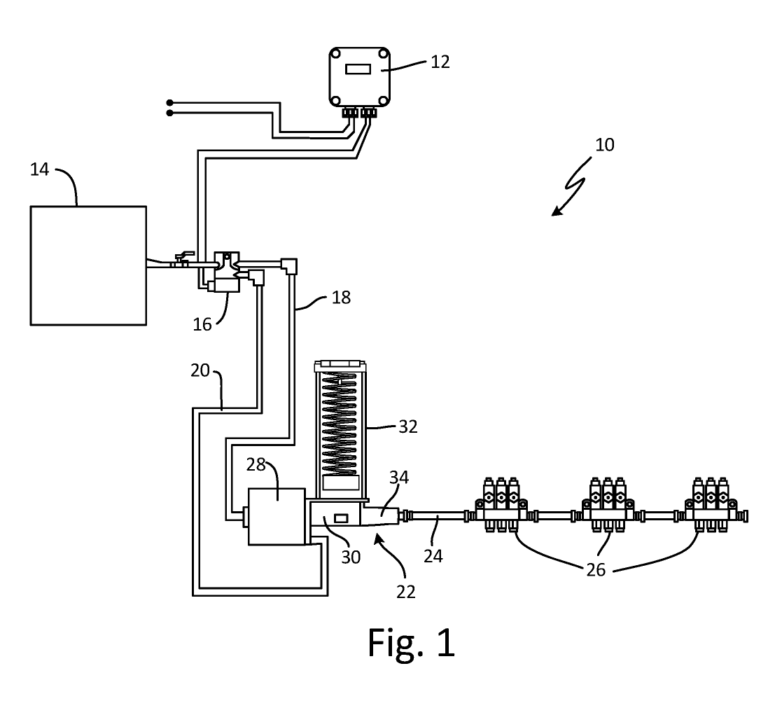

FIG. 1 is a schematic diagram of lubrication system 10, a system that receives, stores, and supplies lubricant fluid. Lubrication system 10 includes control 12, working fluid supply 14, valve 16, first working fluid line 18, second working fluid line 20, lubricant pump 22, lubrication line 24, and lubricant injectors 26. Lubricant pump 22 includes working fluid cylinder 28, base 30, reservoir 32, and outlet valve 34. Working fluid supply 14 is connected to valve 16. Valve 16 is connected to working fluid cylinder 28 through first working fluid line 18 and second working fluid line 20. Working fluid cylinder 28 is secured to base 30. Reservoir 32 is also secured to base 30. Outlet valve 34 is secured to base 30 and to lubrication line 24. Lubricant pump 22 is connected to lubricant injectors 26 by lubrication line 24 extending from outlet valve 34.

Lubricant system 10 is a dedicated lubrication system for use with lubricated machinery such as pumps, pistons, seals, bearings, and/or shafts. Reservoir 32 stores lubricant fluid for distribution to downstream lubricant injectors 26. Lubricant pump 22 builds a pressure in lubrication line 24 until the pressure reaches a pre-determined level. When the pressure in lubrication line 24 reaches the pre-determined level, lubricant injectors 26 dispense a set amount of lubricant fluid to the machinery.

To build pressure in lubricant line 24, lubricant pump 22 is primed with lubricant from reservoir 32. The lubricant, which is typically a grease or oil, is stored within base 30 until such time that the lubricant is to be applied to the machinery. To drive the lubricant downstream from lubricant pump 22, working fluid supply 14 provides a first portion of a working fluid, such as compressed air or hydraulic oil, to working fluid cylinder 28 through valve 16 and first working fluid line 18. Control 12 commands valve 16 to actuate to a first position, whereby the working fluid is directed through first working fluid line 18. The working fluid actuates a piston housed within working fluid cylinder 28 and pushes the piston into a forward stroke, wherein the piston drives a piston rod through base 30. The piston rod drives the lubricant from base 30, through outlet valve 34, and into lubrication line 24 thereby causing a pressure within lubrication line 24 to build. The pressure continues to build within lubrication line 24 as piston continues the forward stroke until the pressure reaches a level sufficient to cause lubricant injectors 26 to dispense lubricant.

After lubricant injectors 26 dispense the lubricant, the pressure in lubrication line 24 is relieved to allow lubricant injectors 26 to reset. Control 12 commands valve 16 to shift to a second position, wherein valve 16 directs working fluid from working fluid supply 14 to an opposite side of the piston through second working fluid line 20, thereby pushing the piston into a return stroke. While the second portion of working fluid is driving the piston into the return stroke, the first portion of working fluid is exhausted from working fluid cylinder 28 through first working fluid line 18 and valve 16. During the return stroke, the piston pulls the piston rod back through base 30, which reduces the lubricant pressure level in base 30 below the lubricant pressure level in lubrication line 24. The pressure differential between the lubricant pressure in base 30 and the lubricant pressure in lubrication line 24 causes lubricant to backflow into base 30 from lubrication line 24 through outlet valve 34, thereby allowing the lubricant pressure within lubrication line 24 to drop. Drawing fluid into base 30 through outlet valve 34 reduces the pressure in lubrication line 24, thereby allowing lubricant injectors 26 to reset for another lubrication cycle. When the piston completes the return stroke, additional lubricant is loaded into base 30 from reservoir 32, priming lubricant pump 22 for another lubrication cycle.

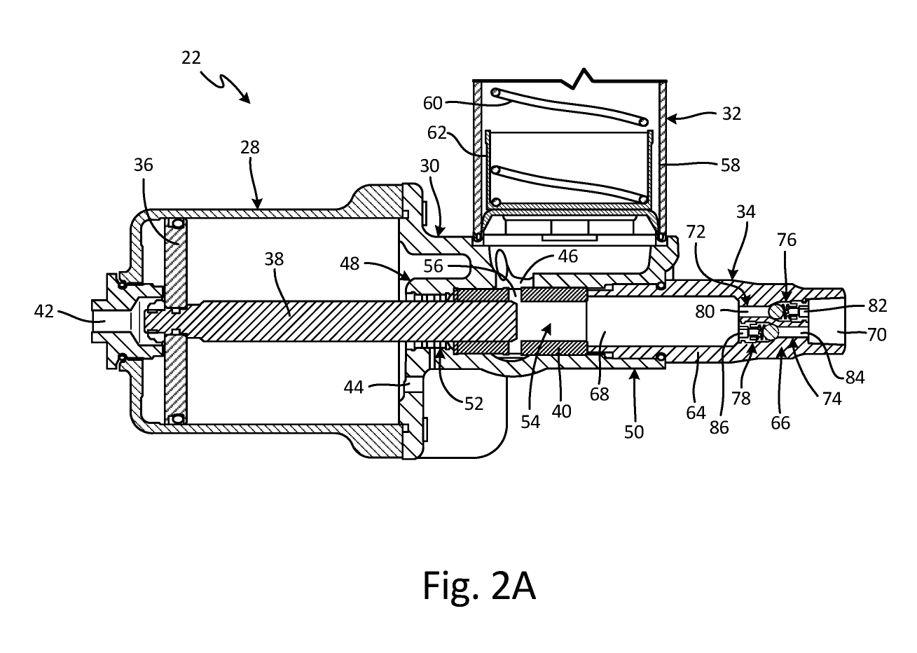

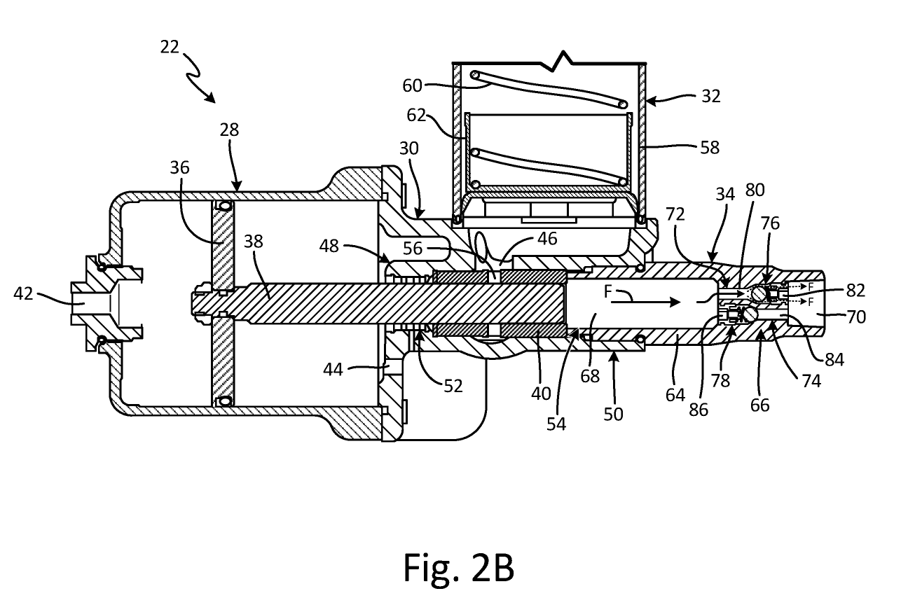

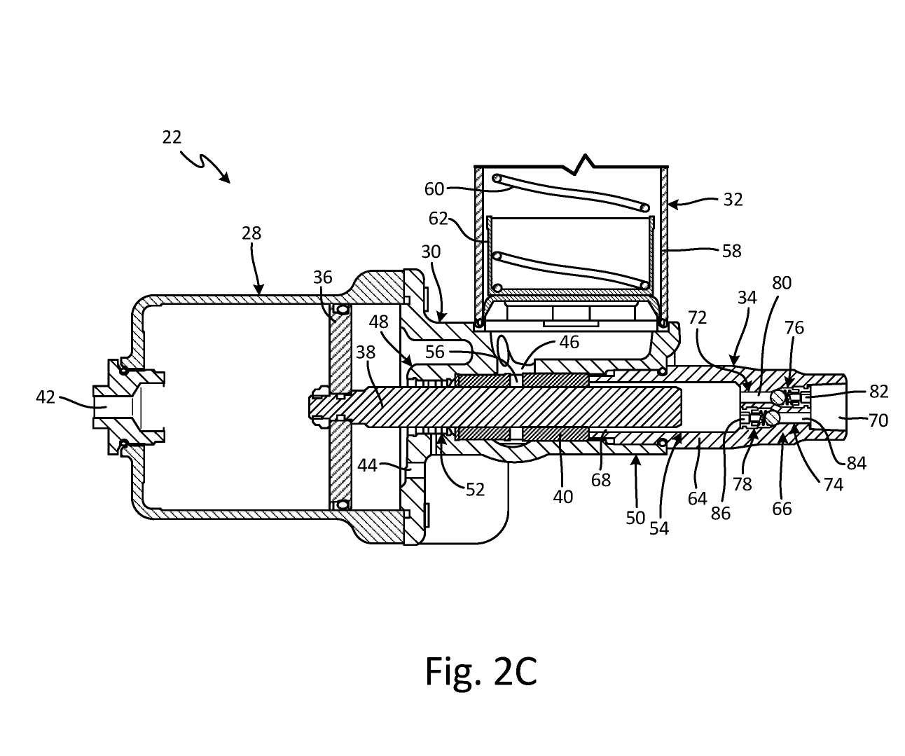

FIG. 2A is a cross-sectional view of lubricant pump 22 in a first operating state of a forward stroke. FIG. 2B is a cross-sectional view of lubricant pump 22 in a second operating state of a forward stroke. FIG. 2C is a cross-sectional view of lubricant pump 22 in a third operating state of a forward stroke. FIGS. 2A-2C are substantially similar and will be discussed together. Lubricant pump 22 includes working fluid cylinder 28, base 30, reservoir 32, outlet valve 34, piston 36, piston rod 38, and pump sleeve 40. Working fluid cylinder 28 includes first working fluid inlet 42. Base 30 includes second working fluid inlet 44, fill port 46, first end 48, second end 50, throat 52, and fluid chamber 54 extending between first end 48 and second end 50. Pump sleeve 40 includes opening 56. Reservoir 32 includes reservoir housing 58, spring 60, and follower plate 62. Outlet valve 34 includes valve body 64 and two-way valve 66. Valve body 64 includes fluid chamber port 68 and system port 70. Two-way valve 66 includes first flow path 72, second flow path 74, first one-way valve 76, and second one-way valve 78. First flow path 72 includes first inlet 80 and first outlet 82, and second flow path 74 includes second inlet 84 and second outlet 86.

Working fluid cylinder 28 is secured to base 30. Piston 36 is disposed within working fluid cylinder 28, and piston rod 38 is secured to piston 36. Piston rod 38 extends from piston 36 through throat 52 and into pump sleeve 40. Pump sleeve 40 is disposed within fluid chamber 54 of base 30 such that opening 56 is aligned with fill port 46. Spring 60 and follower plate 62 are disposed within reservoir housing 58. Follower plate 62 is disposed on top of the lubricant stored within reservoir housing 58. Spring 60 exerts a downward force on follower plate 62. Outlet valve 34 is secured to second end 50 of base 30, and outlet valve 34 extends into base 30 to retain pump sleeve 40 in position within base 30. Reservoir 32 is secured to base 30 proximate fill port 46, and reservoir 32 provides a supply of lubricant to fluid chamber 54 through fill port 46 and opening 56.

Two-way valve 66 is disposed within valve body 64 between fluid chamber port 68 and system port 70. First flow path 72 is disposed adjacent to and runs parallel with second flow path 74. First one-way valve 76 is disposed within first flow path 72 and is configured to allow lubricant to flow from fluid chamber port 68, through first flow path 72, and to system port 70. First one-way valve 76 prevents lubricant from backflowing from system port 70 and to fluid chamber port 68 through first flow path 72. Conversely, second one-way valve 78 is disposed within second flow path 74 and is configured to allow lubricant to flow from system port 70, through second flow path 74, and to fluid chamber port 68. Second one-way valve 78 prevents lubricant from flowing from fluid chamber port 68 and to system port 70 through second flow path 74.

Both first one-way valve 76 and second one-way 78 valve are preferably normally closed valves. For example, first one-way valve 76 may be a ball valve that includes a spring to bias the ball into a closed position. It is understood, however, that first one-way valve 76 may be any suitable valve for selectively allowing fluid to flow downstream from two-way valve 66, such as a poppet valve or a disc valve. Second one-way valve 78 may similarly be an oppositely oriented ball valve that includes a spring to bias the ball into a closed position. Similar to first one-way valve, it is understood that second one-way valve 78 may be any suitable valve for selectively allowing fluid to flow downstream from two-way valve 66, such as a poppet valve or a disc valve. First one-way valve 76 is normally closed and may be opened to allow flow from upstream, in fluid chamber port 68, to downstream, in system port 70. Conversely, second one-way valve 78 is normally closed and may be opened to allow flow from downstream, in system port 70, to upstream, in fluid chamber port 68.

In FIG. 2A, lubricant pump 22 is shown in a first operating state of a forward stroke, wherein lubricant pump 22 is primed with lubricant loaded in fluid chamber 54 and both first one-way valve 76 and second one-way valve 78 in a closed position. Piston 36 is disposed adjacent first working fluid inlet 42 when lubricant pump 22 is in the primed position. Piston rod 38 extends from piston 36, through throat 52, and into base 30. A distal end of piston rod 38 is disposed within pump sleeve 40. While piston rod 38 extends into pump sleeve 40, piston rod 38 does not block opening 56 in pump sleeve 40 while lubricant pump 22 is in the primed position.

In FIG. 2B, lubricant pump 22 is shown in a second operating state of a forward stroke, wherein piston 36 has begun the forward stroke. In response to a signal, working fluid supply 14 (shown in FIG. 1) begins to provide a first portion of working fluid to working fluid cylinder 28 through first working fluid line 18 (shown in FIG. 1) and first working fluid inlet 42. The first portion of working fluid pushes piston 36 into the forward stroke, wherein piston rod 38 is driven further into fluid chamber 54. As piston rod 38 proceeds further into fluid chamber 54, pressure builds within fluid chamber 54 as the lubricant is forced against two-way valve 66.

Both first one-way valve 76 and second one-way valve 78 remain in a closed position as pressure builds within fluid chamber 54. First one-way valve 76 is configured to allow lubricant to flow downstream from fluid chamber 54, through first flow path 72, and to lubrication line 24 (shown in FIG. 1). However, first one-way valve 76 remains in the closed position as pressure begins to build in fluid chamber 54, due to the pressure differential between the lubricant pressure within lubrication line 24 and the lubricant pressure within fluid chamber 54. Pressure builds within fluid chamber 54 until the pressure within fluid chamber 54 is greater than the system pressure within lubrication line 24 and the force holding first one-way valve in the normally closed position. First one-way valve 76 then opens when the pressure within fluid chamber 54 exceeds the combined force of the system pressure and the force biasing first one-way valve 76 closed, such as a spring.

With first one-way valve 76 in the open position, lubricant flows downstream from fluid chamber 54, as shown by flow lines F in FIG. 2B, through first flow path 72 and first one-way valve 76, and into lubrication line 24, which is attached to system port 70. The pressure within lubrication line 24 rises as the piston rod 38 forces more lubricant downstream from fluid chamber 54 and into lubrication line 24. While first one-way valve 76 is actuated to the open positon, second one-way valve 78 remains in the closed position due to second one-way valve 78 being oppositely orientated from first one-way valve 76.

In FIG. 2C, lubricant pump 22 is shown in a third operating state of the forward stroke. Piston rod 38 moves forward through fluid chamber 54 to force lubricant downstream to build pressure in lubrication line 24. Once the system pressure reaches a predetermined level, lubricant injectors 26 (shown in FIG. 1) dispense a set amount of lubricant. When piston rod 38 has completed the forward stroke, the lubricant pressure in lubrication line 24 will be equalized with the lubricant pressure in base 30. With the lubricant pressures equalized, first one-way valve 76 returns to the normally-closed position. Once lubricant has been applied by lubricant injectors 26, the pressure within lubrication line 24 is vented to allow the lubricant injectors 26 to reset for another lubrication cycle.

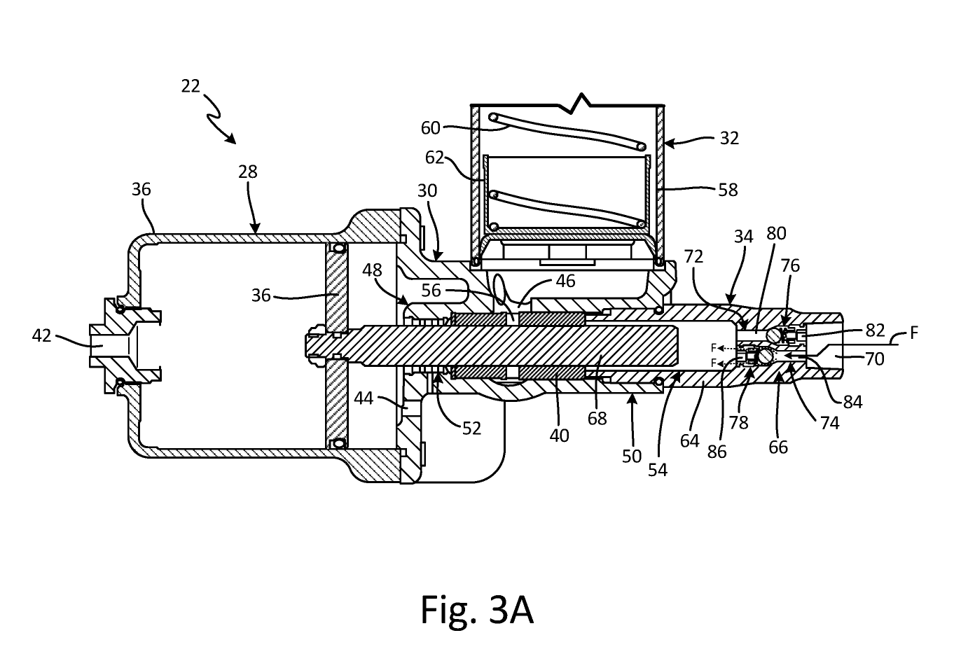

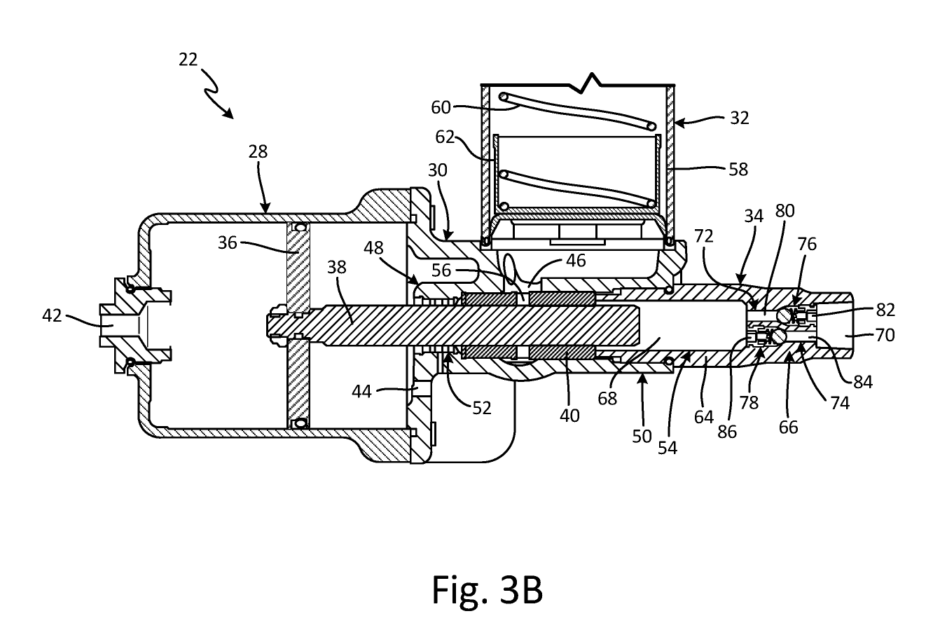

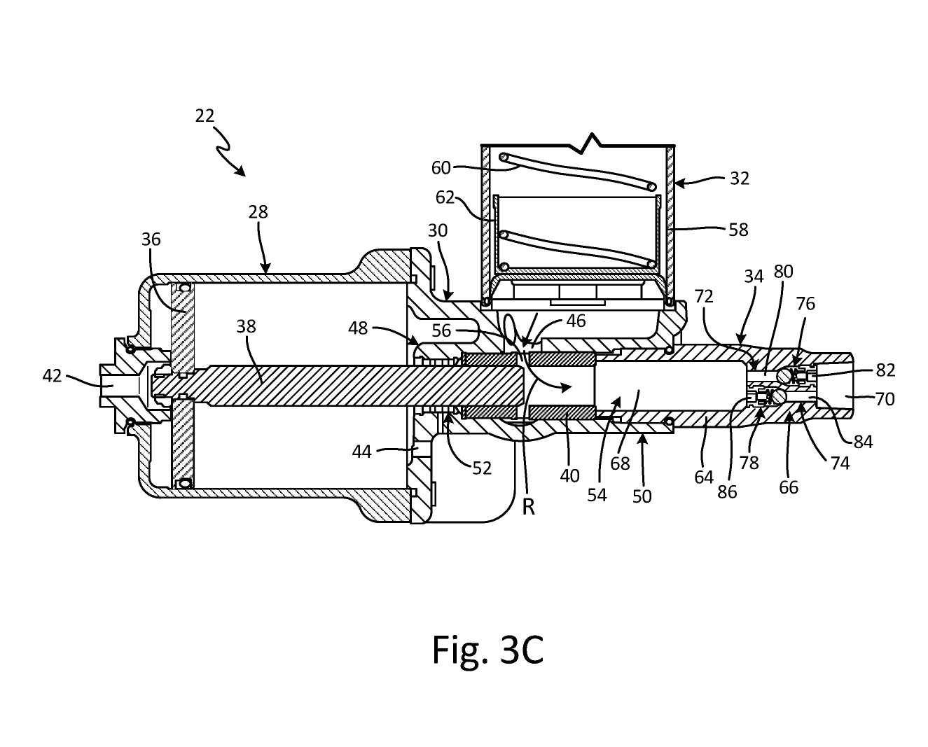

FIG. 3A is a cross-sectional view of lubricant pump 22 in a first operating state of a return stroke. FIG. 3B is a cross-sectional view of lubricant pump 22 in a second operating state of the return stroke. FIG. 3C is a cross-sectional view of lubricant pump 22 in a third operating state of the return stroke. FIGS. 3A-3C are substantially similar and will be discussed together. Lubricant pump 22 includes working fluid cylinder 28, base 30, reservoir 32, outlet valve 34, piston 36, piston rod 38, and pump sleeve 40. Working fluid cylinder 28 includes first working fluid inlet 42. Base 30 includes second working fluid inlet 44, fill port 46, first end 48, second end 50, throat 52, and fluid chamber 54 extending between first end 48 and second end 50. Pump sleeve 40 includes opening 56. Reservoir 32 includes reservoir housing 58, spring 60, and follower plate 62. Outlet valve 34 includes valve body 64 and two-way valve 66 disposed within valve body 64. Valve body 64 includes fluid chamber port 68 and system port 70. Two-way valve 66 includes first flow path 72, second flow path 74, first one-way valve 76, and second one-way valve 78. First flow path 72 includes first inlet 80 and first outlet 82, and second flow path 74 includes second inlet 84 and second outlet 86.

In FIG. 3A, lubrication pump 22 is shown in a first operating state of a return stroke, wherein piston 36 has completed the forward stroke and is beginning the reverse stroke. After piston 36 completes the forward stroke and lubricant injectors 26 have dispensed the lubricant, valve 16 (shown in FIG. 1) shifts such that a second portion of working fluid from working fluid supply 14 (shown in FIG. 1) is provided to working fluid cylinder 28 through second working fluid inlet second working fluid line 20 (shown in FIG. 1) and second working fluid inlet 44. The second portion of working fluid provided through second working fluid inlet 44 forces piston 36 into the reverse stroke. As piston 36 transitions to the reverse stroke, the first portion of working fluid is exhausted through first working fluid inlet 42.

As piston 36 proceeds through the return stroke, piston rod 38 is pulled back through fluid chamber 54. Piston rod 38 being retracted causes a void to begin to expand within fluid chamber 54, which causes the lubricant pressure within fluid chamber 54 to drop. The reduced pressure in fluid chamber 54 creates a pressure differential between the lubricant pressure in fluid chamber 54 and the lubricant pressure in lubrication line 24 (shown in FIG. 1). The higher pressure in lubrication line 24 causes second one-way valve 78 to open, thereby allowing lubricant to flow from lubrication line 24, through system port 70 and second flow path 74, and into fluid chamber 54, as shown by flow lines F in FIG. 3A. The lubricant backflowing into fluid chamber 54 causes the pressure within lubrication line 24 to drop, thereby allowing lubricant injectors 26 to reset.

In FIG. 3B, lubrication pump 22 is shown in a second operating state of the return stroke. As piston 36 continues through the return stroke, the pressure within lubrication line 24 approaches the pressure in fluid chamber 54. When the pressure differential drops below the level required to maintain second one-way valve 78 in the open position, second one-way valve 78 shifts from the open position to the normally closed position. Once second one-way valve 78 returns to the closed position, both first one-way valve 76 and second one-way valve 78 are closed. However, piston 36, and therefore piston rod 38, continues through the reverse stroke.

Once second one-way valve 78 returns to the closed position, no lubricant is entering fluid chamber 54 from lubrication line 24. As such, as piston rod 38 continues to retract through fluid chamber 54 a void is created between piston rod 38 and two-way valve 66. The void continues to expand as piston rod 38 is pulled through the remainder of the return stoke.

In FIG. 3C, lubrication pump 22 is shown in a third operating state of the return stroke, wherein piston 36 returns to the position shown in FIG. 2A and lubrication pump 22 is primed for the next lubrication cycle. As piston 36 continues along the return stroke, the void created in fluid chamber 54 continues to expand. However, the force maintaining second one-way valve 78 in the normally closed position is stronger than the suction force created by the void, and as such second one-way valve 78 remains in the closed position as the void expands. As piston 36 nears the end of the return stroke, the distal end of piston rod 38 passes opening 56 in pump sleeve 40. When the distal end of piston rod 38 passes opening 56, the void draws the lubricant stored within reservoir housing 58 into fluid chamber 54 through opening 56, as shown by flow lines R. With lubricant loaded in fluid chamber 54 and piston 36 having completed the return stroke, lubricant pump 22 is primed for the next lubrication cycle.

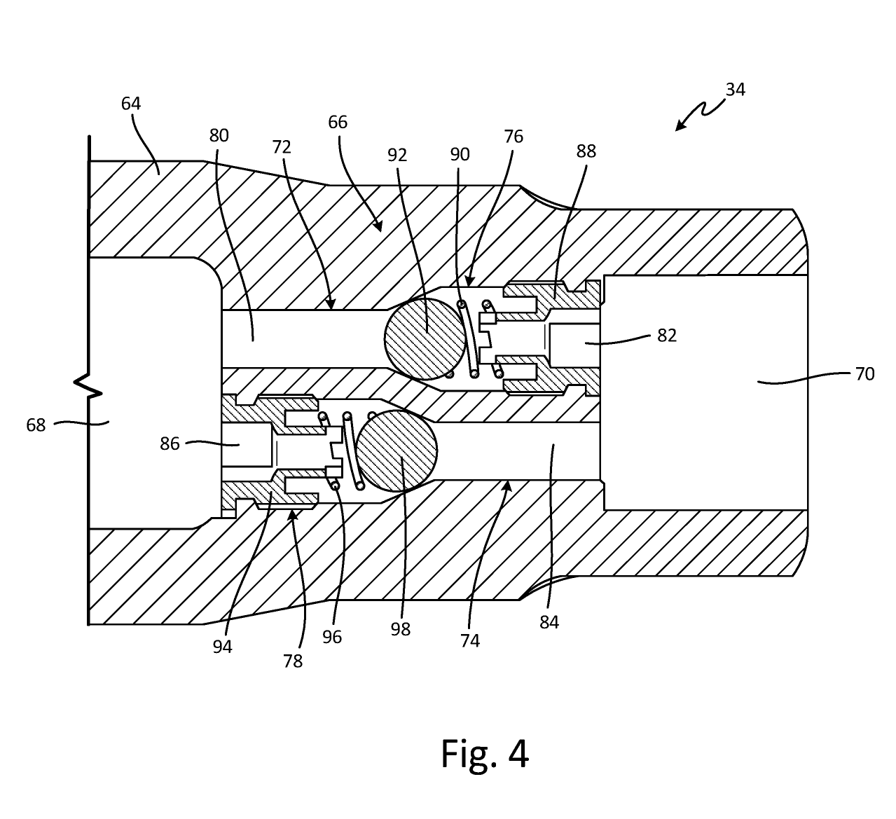

FIG. 4 is a cross-sectional view of outlet valve 34. Outlet valve 34 includes valve body 64 and two-way valve 66 disposed within valve body 64. Valve body 64 includes fluid chamber port 68 and system port 70. Two-way valve 66 includes first flow path 72, second flow path 74, first one-way valve 76, and second one-way valve 78. First flow path 72 includes first inlet 80 and first outlet 82. Second flow path 74 includes second inlet 84 and second outlet 86. First one-way valve 76 includes first retainer 88, first spring 90, and first ball 92. Second one-way valve 78 includes second retainer 94, second spring 96, and second ball 98.

Two-way valve 66 is disposed within valve body 64 between fluid chamber port 68 and system port 70. First flow path 72 extends between and connects fluid chamber port 68 and system port 70, and second flow path 74 also extends between and connects fluid chamber port 68 and system port 70. First flow path 72 is adjacent to and runs substantially parallel with second flow path 74. First one-way valve 76 is disposed within first flow path 72 and is configured to allow lubricant to flow downstream from fluid chamber port 68 to system port 70 when first one-way valve 76 is in the open position. First retainer 88 is secured to first outlet 82, with first ball 92 disposed within first flow path 72 upstream of first retainer 88. First spring 90 is disposed between first retainer 88 and first ball 92, and first spring 90 biases first ball 92 in the upstream direction, such that first one-way valve 76 is normally closed. A diameter of first outlet 82 is preferably greater than a diameter of first inlet 80 such that first inlet 80 functions as a seat for first ball 92 when first one-way valve is in the closed position. However, it is understood that first one-way valve 76 may include a seat against which first ball 92 is biased when in the closed position.

Second one-way valve 78 is disposed within second flow path 74 and is configured to allow lubricant to flow upstream from system port 70 and to fluid chamber port 68 when second one-way valve 78 is in the open position. Second retainer 94 is secured to second outlet 86, and second ball 98 is disposed within second flow path 74 downstream of second retainer 94. Second spring 96 is disposed between second retainer 94 and second ball 98. Second spring 96 biases second ball 98 in the downstream direction, such that second one-way valve 78 is normally closed. A diameter of second outlet 86 is preferably greater than a diameter of second inlet 84 such that second inlet 84 functions as a seat for second ball 98 when second one-way valve is in the closed position. However, it is understood that second one-way valve 78 may include a seat against which second ball 98 is biased when in the closed position. While two-way valve 66 is described as including a first ball valve and a second ball valve, it is understood that two-way valve 66 may include any suitable valve configuration, such as a first poppet valve and a second poppet valve or a first disc valve and a second disc valve.

During operation, first one-way valve 76 allows lubricant to flow downstream from fluid chamber port 68, through first flow path 72, and to system port 70. Second one-way valve 78 allows lubricant to flow upstream from system port 70, through second flow path 74, and to fluid chamber port 68. When lubricant pump 22 (shown in FIGS. 2A-3C) is in the primed position (shown in FIG. 2A), both first one-way valve 76 and second one-way valve are in the closed position, thereby preventing lubricant from flowing between fluid chamber port 68 and system port 70.

As lubricant pump 22 proceeds through the forward stroke (shown in FIGS. 2A-2C), an upstream pressure builds within fluid chamber port 68 adjacent two-way valve 66. The upstream pressure continues to build until the force of the upstream pressure exceeds the combined force of the downstream pressure and first spring 90. The pressure differential then causes first ball 92 to shift from the closed position to the open position to allow lubricant to flow downstream from fluid chamber port 68, through first flow path 72, and through system port 70. The lubricant flows through first one-way valve 76 to build downstream pressure in lubrication line 24 (shown in FIG. 1). The pressure within lubrication line 24 builds until the pressure reaches a level sufficient to cause lubricant injectors 26 (shown in FIG. 1) to dispense lubricant. Second one-way valve 78 remains in the closed position as the upstream pressure builds to a sufficient level to actuate first one-way valve 76 to the open position. In fact, the system pressure actually biases the second one-way valve 78 towards the closed position, as second one-way valve 78 is oppositely oriented from first one-way valve 76. The downstream system pressure continues to build until lubricant injectors 26 dispense the lubricant.

After lubricant injectors 26 have dispense the lubricant, first spring 90 shifts first one-way valve 76 back to the closed position from the open position. The lubricant pump 22 then begins the reverse stroke (shown in FIGS. 3A-3C) to reset for the next lubrication cycle. As lubricant pump 22 enters the reverse stroke the retracting piston rod 38 creates a void within fluid chamber port 68 thereby dropping the upstream pressure within fluid chamber port 68. The upstream pressure continues to drop until the pressure differential between the downstream pressure and the upstream pressure overcomes the force applied by second spring 96, and second ball 98 shifts to the open position. With second ball 98 in the open position lubricant is free to flow upstream from system port 70 and to fluid chamber port 68 through second flow path 74. The system pressure subsequently drops as the lubricant drains upstream through second flow path 74. The drop in system pressure allows the lubricant injectors 26 to reset for the next lubrication cycle. As the pressure differential between the system pressure and the upstream pressure drops, second spring 96 is able to reseat second ball 98, thereby resetting second one-way valve 78 to the closed position. With second ball 98 reseated, lubricant is prevented from flowing upstream from lubrication line 24 and to fluid chamber 54.

With second one-way valve 78 in the closed position, a void is created in fluid chamber 54 upstream of two-way valve 66 as piston rod 38 continues to retract. While the void exerts a force on second ball 98, pulling second ball 98 towards the open position, second spring 96 exerts sufficient force to maintain second ball 98 in the closed position. The void continues to expand as lubricant pump transitions from the second operating state of the return stroke (shown in FIG. 3B) to the third operating state of the return stroke (shown in FIG. 3C). When lubricant pump 22 completes the return stroke, lubricant from reservoir 32 (shown in FIGS. 2A-3C) fills the void and lubricant pump 22 is again primed for another lubrication cycle.

The two-way valve described herein provides several advantages. First one-way valve 76 running parallel to second one-way valve 78 reduces the number of components of the outlet valve of a lubricant pump. First one-way valve 76 is independent of second one-way valve 78, but first one-way valve 76 and second one-way valve 78 are disposed within the same valve body 64. Housing first one-way valve 76 and second one-way valve 78 independently, but within the same body, eliminates additional components required to allow flow in both the upstream and downstream direction, thereby reducing the cost associated with outlet valves. In addition, first one-way valve 76 and second one-way valve 78 may be relatively simple in nature, such as ball check valves, thereby decreasing the cost associated with complex, intricate valve assemblies.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An outlet valve for a lubricant pump, the outlet valve comprising:
a valve body having a fluid chamber port and a system port; and
a two-way valve disposed within the valve body between the fluid chamber port and the system port, the two-way valve comprising:
a first flow path having a first inlet adjacent the fluid chamber port and a first outlet adjacent the system port;
a first one-way valve disposed within the first flow path, wherein the first one-way valve is configured to allow flow from the first inlet to the first outlet;
a second flow path extending parallel to the first flow path, the second flow path having a second inlet adjacent the system port and a second outlet adjacent the fluid chamber port; and
a second one-way valve disposed within the second flow path, wherein the second one-way valve is configured to allow flow from the second inlet to the second outlet.

2. The outlet valve of claim 1, wherein the first one-way valve is a normally closed valve and the second one-way valve is a normally closed valve.

3. The outlet valve of claim 2, wherein the first one-way valve is a first ball check valve, and wherein the second one-way valve is a second ball check valve.

4. The outlet valve of claim 3, and wherein:
the first ball check valve comprises:
a first retainer secured to the first outlet;
a first ball disposed within the first flow path between the first retainer and the first inlet; and
a first spring disposed between the first retainer and the first ball; and
the second ball check valve comprises:
a second retainer secured to the second outlet;
a second ball disposed within the second flow path between the second retainer and the second inlet; and
a second spring disposed between the second retainer and the second ball.

5. The outlet valve of claim 4, wherein the first outlet has a first diameter and the first inlet has a second diameter, and wherein the first diameter is greater than the second diameter.

6. The outlet valve of claim 4, wherein the second outlet has a first diameter and the second inlet has a second diameter, and wherein the first diameter is greater than the second diameter.

7. The outlet valve of claim 2, wherein the first one-way valve is a first poppet valve and wherein the second one-way valve is a second poppet valve.

8. The outlet valve of claim 2, wherein the first one-way valve is a first disc valve and wherein the second one-way valve is a second disc valve.

9. A lubricant pump comprising:
a pump base defining a fluid chamber, and having a throat, a fill port, and an outlet port;
a working fluid cylinder attached to the pump base;
a lubricant reservoir attached to the pump base, and configured to provide lubricant to the fluid chamber through the fill port;
a piston disposed within the working fluid cylinder;
a piston rod extending from the piston and into the fluid chamber through the throat; and
an outlet valve attached to the outlet port, wherein the outlet valve comprises:
a valve body having a fluid chamber port and a system port, wherein the fluid chamber port is disposed within the outlet port; and
a two-way valve disposed within the valve body between the fluid chamber port and the system port, the two-way valve comprising:
a first flow path having first inlet adjacent the fluid chamber port and a first outlet adjacent the system port;
a first one-way valve disposed within the first flow path, wherein the first one-way valve is configured to allow lubricant to flow downstream from the fluid chamber;
a second flow path extending parallel to the first flow path, the second flow path having a second inlet adjacent the system port and a second outlet adjacent the fluid chamber port; and
a second one-way valve disposed within the second flow path, wherein the second one-way valve is configured to allow lubricant to flow upstream to the fluid chamber.

10. The lubricant pump of claim 9, wherein the first one-way valve is a normally closed valve, and wherein the second one-way valve is a normally closed valve.

11. The lubricant pump of claim 10, wherein the first one-way valve is a first ball check valve, and the second one-way valve is a second ball check valve.

12. The lubricant pump of claim 11, and wherein:
the first ball check valve comprises:
a first retainer secured to the first outlet;
a first ball disposed within the first flow path between the first retainer and the first inlet; and
a first spring disposed between the first retainer and the first ball; and
the second ball check valve comprises:
a second retainer secured to the second outlet;
a second ball disposed within the second flow path between the second retainer and the second inlet; and
a second spring disposed between the second retainer and the second ball.

13. The outlet valve of claim 12, and wherein:
the first outlet has a first outlet diameter and the first inlet has a first inlet diameter, and wherein the first outlet diameter is greater than the first inlet diameter; and
the second outlet has a second outlet diameter and the second inlet has a second inlet diameter, and wherein the second outlet diameter is greater than the second inlet diameter.

14. A lubrication system comprising:
a pump comprising:
a pump base defining a fluid chamber, and having a throat, a fill port, and an outlet port;
a working fluid cylinder attached to the pump base;
a lubricant reservoir attached to the pump base, and configured to provide lubricant to the fluid chamber through the fill port;
a piston disposed within the working fluid cylinder;
a piston rod extending from the piston and into the fluid chamber through the throat; and
a pump outlet check valve attached to the outlet port, the outlet check valve comprising:
a valve body having a fluid chamber port and a system port, wherein the fluid chamber port is disposed within the outlet port; and
a two-way valve disposed within the valve body between the fluid chamber port and the system port, the two-way valve comprising:
a first flow path having first inlet adjacent the fluid chamber port and a first outlet adjacent the system port;
a first one-way valve disposed within the first flow path, wherein the first one-way valve is configured to allow lubricant to flow downstream from the fluid chamber;
a second flow path extending parallel to the first flow path, the second flow path having a second inlet adjacent the system port and a second outlet adjacent the fluid chamber port; and
a second one-way valve disposed within the second flow path, wherein the second one-way valve is configured to allow lubricant to flow upstream to the fluid chamber;
a lubricant supply line connected to the system port, and configured to provide lubricant downstream to lubricant applicators; and
a working fluid supply connected to the working fluid cylinder through a first working fluid supply line and a second working fluid supply line;
wherein the first working fluid supply line provides working fluid to the working fluid cylinder to drive the piston in a forward stroke; and
wherein the second working fluid supply line provides working fluid to the working fluid cylinder to drive the piston in a reverse stroke.

15. The lubrication system of claim 14, wherein the working fluid comprises compressed gas.

16. The lubricant pump of claim 14, wherein the first one-way valve is a normally closed valve and the second one-way valve is a normally closed valve.

17. The lubricant pump of claim 16, wherein the first one-way valve is a first ball check valve, and the second one-way valve is a second ball check valve.

18. The lubricant pump of claim 17, and wherein:
the first ball check valve comprises:
a first retainer secured to the first outlet;
a first ball disposed within the first flow path between the first retainer and the first inlet; and
a first spring disposed between the first retainer and the first ball; and
the second ball check valve comprises:
a second retainer secured to the second outlet;
a second ball disposed within the second flow path between the second retainer and the second inlet; and
a second spring disposed between the second retainer and the second ball.

19. The outlet valve of claim 16, wherein the first one-way valve is a first poppet valve and wherein the second one-way valve is a second poppet valve.

20. The outlet valve of claim 16, wherein the first one-way valve is a disc valve and wherein the second one-way valve is a disc valve.
